(19) United States
(12) Patent Application Publication
(10) Pub. No.: US 2014/0342699 A1
(43) Pub. Date: Nov. 20, 2014

(54) Software application to reduce distractions while in motion

(71) Applicants: Sean Patrick Smith, Anchorage, AK (US); Pavan R. Madhineni, Parker, CO (US)

(72) Inventors: Sean Patrick Smith, Anchorage, AK (US); Pavan R. Madhineni, Parker, CO (US)

(21) Appl. No.: 13/986,648

(22) Filed: May 20, 2013

(51) Int. Cl. H04W 12/08

(52) U.S. Cl. CPC H04W 12/08
USPC 455/411

(57) ABSTRACT

Our invention seeks to disable or impede smartphones, mobile devices, or tablet's keyboards, keypads, numerical keypads, or voice recognition software from being used while in motion at speeds in excess of 3 MPH, thereby eliminating distractions while in motion.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of software. More particularly, the present invention is in the technical field of application software. More particularly, the present invention is in the technical field of application software for smartphones, mobile devices, and tablets.

Conventional software is generally referred to as system software, the main functions being those which do not directly benefit the user, but rather control the operating system in the background. This system software performs duties for the application software, which in turn serves the user. Application software is all of the software on devices which serve a particular interest, purpose, or function for the user. This is often achieved by applying the power of specific computer platforms or system software to achieve the desired outcome.

### SUMMARY OF THE INVENTION

The present invention is a software application that will prevent users from typing on a device while in motion, thereby minimizing distractions caused by using the device while in motion.

### BRIEF DESCRIPTION OF THE DRAWING

FIG. 1 is a detailed process flow of activities to execute the present invention.

### DETAILED DESCRIPTION OF THE INVENTION

Our software will prevent users from typing on the keyboard, keypad, or numerical keypad while driving, or traveling at any speed greater than X miles per hour (MPH), where X would be anything greater than 3 MPH. Our software application will also disable or impede users from using voice commands, or voice-to-text, such as Siri.

We have developed a software application which disables or impedes the keyboard, keypad, numerical keypad, or voice recognition software on a smartphone, mobile device, or tablet while moving at any speed greater than 3 MPH. The software application can disable or impede only the keyboard and leave the keypad fully functional, disable or impede only the keypad and leave the keyboard fully functional, or disable or impede both the keyboard and keypad. In addition there will also be the option to disable or impede voice recognition software along with any of the previously mentioned combinations. Our preferred method of usage for this application would be to disable or impede all of the aforementioned components; the keyboard, keypad, numerical keypad, and voice recognition software. However, there will continue to be access to the emergency call (911) feature built into the devices, regardless of which configuration the user chooses.

The software will require the use of GPS, which can yield instantaneous velocity measurements, in order to determine if the device is traveling at a speed greater than 3 MPH. Only devices that are GPS enabled will be able to use this software. The software application will require user-consent, allowing the application to use the GPS capabilities built within the smartphone, mobile device, or tablet. We will determine via the aforementioned built-in GPS capabilities that if you are in motion at speeds greater than 3 MPH, the software application will disable or impede the keyboard, keypad, voice recognition, or any combination of those devices.

The software application will disable or impede the keyboard, keypad, voice recognition, or any combination of those devices when they are being used while in motion at speeds greater than 3 MPH. If that motion stops for any reason the application will wait for 60 seconds to confirm motion has ceased. Once the threshold of 60 seconds has been surpassed, the software application will re-enable the usage of the keyboard, keypad, voice recognition, or any combination of those devices and allow the user to input text or voice commands again as normal, provided the device maintains motion at speeds less than 3 MPH.

We would require an administrative password to be input in order to bypass the application. This would require the administrative password to be set by the user upon installation of the software application. We have also implemented a feature within the software allowing the user to toggle between “Driver” and “Passenger” mode, whereby in passenger mode the restrictions on motion would be exempted. A third option is that of being able to bypass the application directly from our web-site. A series of five failed attempts to bypass the application would require a 24-hour period before the user is allowed to attempt to bypass the application again. In essence, once the application is downloaded to the user's device, it will run in perpetuity unless one of the above referenced methods is utilized.

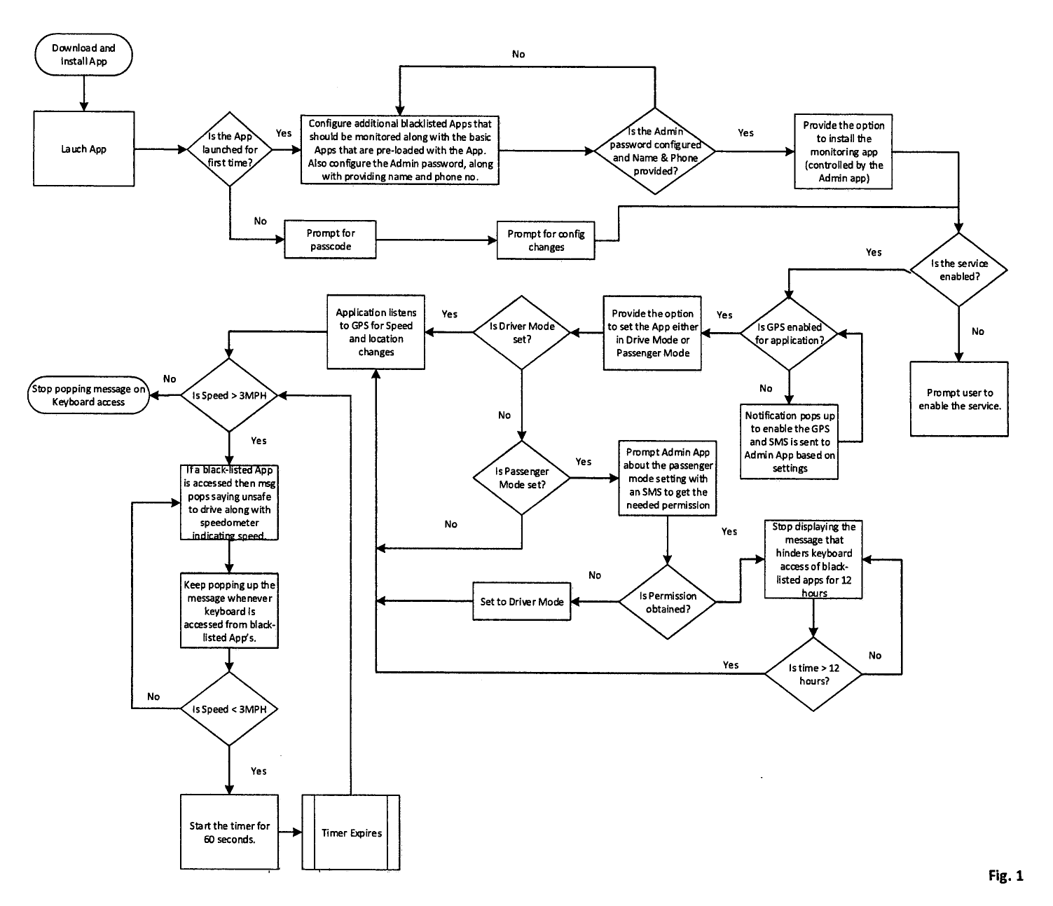

Referring now to the invention in more detail, in FIG. 1 there is shown a process flow of how the software is activated and the steps that are undertaken to achieve our desired results; which is to reduce distractions from smartphones, mobile devices, and tablets while they are being used, when the user is in motion at speeds greater than 3 MPH. The flow of the software will be as follows:

The application will be downloaded and installed by the user through the smartphone, mobile device, or tablet's Application Store or directly from our company's web-site.

The user will launch the application.

The application will run in the background and disable or impede the keyboard, keypad, voice recognition, or any combination of those from being accessed whenever the user tries to navigate to any kind of text-field, within ANY application, that is currently running in the foreground of the installed smartphone, mobile device, or tablet that would pop-up the keyboard, allowing the user to type.

In further detail, still referring to the invention of FIG. 1, the process flow illustrates how the application is initially installed onto the device(s) and the security that will be enabled in order to install correctly. From there the process flow shows the detailed steps our invention takes to produce the desired results, beginning with the mode selection of either Driver (restrictions imposed for speeds greater than 3 MPH) or Passenger (restrictions on motion exempted), activation and listening of the GPS system, followed by the subsequent operations to disable or impede input devices while in motion. In addition, there is also connotation noting the steps necessary for the software to discern a lack of motion and the re-enabling of the input devices.

The advantages of the present invention include, without limitation, the ability to have users of smartphones, mobile devices, and tablets focused on their means of transportation and immediate surroundings, rather than their particular device(s) and all associated distractions that come with them.

In broad embodiment, the present invention is a software application to disable or impede the keyboard, keypad, or voice recognition software while in motion at speeds greater than 3 MPH.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. Our invention severely decreases the likelihood of injuries or death being sustained while using any of the previously referenced devices while in motion by eliminating the possibilities of typing into text fields, including, but not limited to, those associated with:
Text messaging
Emails
Internet access
Telephonic services, and
Any other applications requiring a method of touch typing form of input.

2. Our invention is capable of working on any devices in motion including, but not limited to, those in motion via:
An automobile or machinery,
Any form of aviation,
Bicycle,
Skateboard or skates,
Bi-pedal, or
Any other method of transportation where motion in excess of 3 MPH is taking place.

3. It is also our claim, that while there are other inventions doing similar actions to what ours does e.g., disabling text messaging while in motion, disabling email messaging while in motion, or disabling telephonic services while in motion, there is currently no other application completely disabling or impeding the keyboard, keypad, numerical keypad, or voice recognition software while in motion, thus eliminating distractions from smartphones, mobile devices, or tablets while in motion and reducing the likelihood of injuries or death to the user or other persons.
